(19) United States
(12) Patent Application Publication
(10) Pub. No.: US 2008/0318079 A1
(43) Pub. Date: Dec. 25, 2008

(54) LOW LEAD SOLDERABLE PLUMBING COMPONENTS

(76) Inventors: George J. Ballantyne, Granger, IN (US); Benjamin L. Lawrence, Elkhart, IN (US)

Correspondence Address: George J. Ballantyne, 16377 OakHill Blvd., Granger, IN, 46530, US

(21) Appl. No.: 12/141,361

(22) Filed: Jun. 18, 2008

Related U.S. Application Data
(60) Provisional application No. 60/945,391, filed on Jun. 21, 2007.

(51) Int. Cl. B32B 15/01; B23K 1/20; C25D 5/00; F16K 51/00

(52) U.S. Cl. 428/615; 228/208; 205/96; 137/454.2

(57) ABSTRACT

Plumbing valves, fittings, and other water handling devices are manufactured of a metal, such as silicon bronze, having a lead content below 0.2%. Such devices are subsequently electroplated with a galvanizing solution including saline or alkaline solutions containing nickel and tin. The resultant plated products can be soldered to the remaining copper components of a plumbing system using conventional lead-free solder.

### CROSS-REFERENCE TO RELATED APPLICATIONS

This application claims priority under 35 U.S.C. § 119(e) on U.S. Provisional Application No. 60/945,391 entitled LOW LEAD SOLDERABLE PLUMBING DEVICES, filed on Jun. 21, 2007, by George J. Ballantyne, et al., the entire disclosure of which is incorporated herein by reference.

### BACKGROUND OF THE INVENTION

The present invention relates to plumbing devices, such as valves and fittings, which have a moderate to high silicon content and yet are capable of soldering to conduits to complete flow paths.

In recent years, the lead content in potable water has become of greater concern, particularly with the younger population. California has passed Assembly Bill 1953 which, beginning in the year 2010, limits the amount of lead content in plumbing devices for potable water to less that 0.25%. Pending federal legislation popularly referred to as the “lead-free drinking act of 2007”, proposes limiting the lead content in plumbing devices for potable water to less than 0.2%. Accordingly, conventional bronze plumbing devices, such as valves, fittings, and the like, which have a lead content significantly higher than (i.e., 4%-7%) would not meet the new proposed standards. In order to comply with the new standards, therefore, conventional bronze materials cannot be employed.

One alternative is to utilize a silicon bronze alloy which reduces the lead content to below the 0.2% level. Valves and fittings made of a silicon bronze alloy, however, require brazing as opposed to lead-free soldering when coupling to copper tubing and other fittings. Brazing requires a much higher temperature, typically provided by an acetylene torch or the like, which requires specialized skills of the tradesman. Also, the use of brazing temperatures can increase somewhat the potential for fire hazards, particularly at a construction site where numerous brazed joints are required. Accordingly, the use of silicon bronze does not appear upon initial investigation as a viable alternative.

### SUMMARY OF THE INVENTION

It has been discovered that the use of low lead content silicon bronze, when electroplated in a galvanizing solution including a nickel and tin alloy, allows the plumbing fitting to be soldered utilizing conventional relatively low temperature lead-free solder, thereby providing plumbing fixtures which comply with future standards for lead-free potable water handling devices.

According to one embodiment of the invention, therefore, plumbing valves, fittings, and other potable water handling components are manufactured of silicon bronze having a lead content below 0.2%. Such components are subsequently electroplated with a galvanizing solution including saline or alkaline solutions containing nickel and tin. The resultant plated products can be soldered to the remaining copper components of a plumbing system using conventional lead-free solder. Other low lead metals, such as silicon brass, aluminum bronze, and other alloys generally not considered solderable, can be employed when treated according to the method of this invention.

These and other features, objects and advantages of the present invention will become apparent upon reading the following description thereof together with reference to the accompanying drawings.

### BRIEF DESCRIPTION OF THE DRAWINGS

FIG. 1 is a perspective view of a valve incorporating the present invention;

FIG. 2 is a perspective view of a fitting incorporating the present invention;

FIG. 3 is a greatly enlarged fragmentary cross-sectional view of the valve shown in FIG. 1, taken along section line III-III;

FIG. 4 is a schematic view of a plumbing system incorporating fittings and methods of the present invention;

FIG. 5 is a flow diagram of the process of manufacturing plumbing components embodying the present invention; and

FIG. 6 is an enlarged fragmentary cross-sectional view of the circled area VI of FIG. 4.

### DETAILED DESCRIPTION OF THE PREFERRED EMBODIMENT

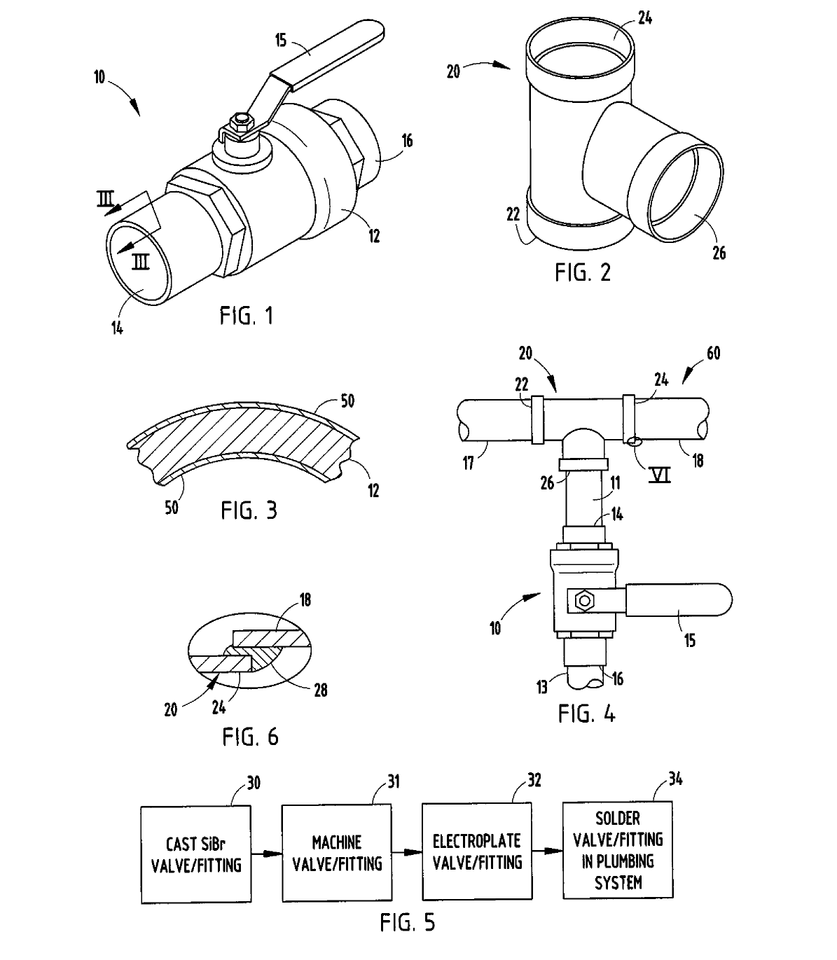

Referring initially to FIGS. 1 and 2, there is shown in FIG. 1 a ball valve 10, which is cast of silicon bronze material, machined, and subsequently electroplated with a nickel tin alloy, as described below, to provide solderability for the valve. The valve body 12 and internal components, such as the ball of the ball valve itself, are also cast of silicon bronze having a lead content of less than 0.2%. The valve 10 includes sockets 14 and 16 at opposite ends which, as seen in the circuit of FIG. 4, receive conventional copper tubing, such as tube 11 entering valve 10 and tube 13 exiting valve 10. With the electroplated valve 10, the tubes or conduits 11, 13 can be conventionally lead-free soldered to the valve body 12. Valve 10 includes a control handle 15 for actuating a ball within the valve body between a fully open position (FIG. 1) and adjustable closed positions to a fully closed position, generally shown in FIG. 4.

The fitting 20 of FIG. 2 comprises a silicon bronze “T” which is also cast, as described below, of a silicon bronze material, also having a lead content of less than 0.2%. The fitting 20 is subsequently machined and electroplated with a nickel tin alloy to provide low lead solderability to the fitting 20, which is shown coupled in the plumbing circuit in FIG. 4 with an input socket 22 soldered to a copper water supply tube 17, an outlet socket 24 receiving and soldered to an outlet copper tube 18. A “T” outlet socket 26 receives conduit 11 leading to valve 10 in the example circuit shown in FIG. 4. The interconnection of the copper tubes to the “T” 20 and valve 10 is made using conventional lead-free solder 28 (FIG. 6) employing standard soldering techniques.

The valve and fitting shown in FIGS. 1 and 2 are illustrative only of numerous plumbing components or devices, including a variety of valves, connectors, and fittings, including Y's, elbows, unions, and the like, which are typically manufactured of conventional bronze. Such designs are available from NIBCO Inc. of Elkhart, Ind., in a variety of sizes shapes, and styles but, in view of the new low lead guidelines, instead of casting the fittings, such as those shown in FIGS. 1 and 2, of conventional bronze alloy which includes from 4% to 7% lead, silicon bronze is employed for the devices.

As seen in FIG. 3, the body 12, for example, of valve 10 is made of a silicon bronze alloy, such as C87800, which preferably comprises copper at about 82%, silicon at about 4% and zinc at about 14%. Normal impurities may include the following percentages of other metals at about the percentages indicated:

TABLE 1

| | Cu | Al | Sb | As | Fe | Pb | Mg | Mn | Ni⁽¹⁾ | P | Si | S | Sn | Zn |
|---|---|---|---|---|---|---|---|---|---|---|---|---|---|---|
| Min/Max | 80.0 min | .15 | .05 | .05 | .15 | .15 | .01 | .15 | .20 | .01 | 3.8-4.2 | .05 | .25 | 12.0-16.0 |

Lead may be present at a maximum level of about 0.15% and preferably does not exist in the purest form of the C87800 alloy. Similarly, other silicon bronze alloys can also be employed, such as C87610, which preferably comprises copper at about 92%, silicon at about 4%, and zinc at about 4%. Normal impurities may include the following percentages of other metals at about the percentages indicated:

TABLE 2

| | Cu | Fe | Pb | Mn | Si | Zn |
|---|---|---|---|---|---|---|
| Min/Max | 90.0 min | .20 | .20 | .25 | 3.0-5.0 | 3.0-5.0 |

Lead may be present at less than 0.2% and preferably does not exist. The bodies and component parts of the valves and fittings are cast utilizing either a conventional green sand foundry casting process or utilizing a metal mold in a die casting machine in the process shown by block 30 in FIG. 5.

Subsequent to the casting of the plumbing devices and any finishing to the cast part, such as burr or flash removal by machining (block 31, FIG. 5), the parts are entirely electroplated on inner and outer surfaces with a tin nickel alloy 50, as shown in FIG. 3 and as shown by the step of block 32 in FIG. 5. The electroplating is accomplished in a conventional electroplating tank utilizing an electrolytic nickel as an anode and a plumbing component to be plated as the cathode. The electroplating solution is heated to approximately 50° C. and the plating process takes approximately 15 minutes at a current density of 1 to 1.5 A/dm² and at a pH of about 4.4 to 4.5. The bath includes nickel chloride in a concentration of about 230 to 250 g/l and a combination of tin chloride ammonia bifluoride and diethylenetriamine as a second aqueous component at a concentration of 500 g/l. The electroplating process results in a coating 50 having a bright shiny chrome-like appearance (depending upon the smoothness of the cast part) and a hardness of about 400 D.P.H. (diamond pyramid hardness).

During the plating process, the temperature can range between 50° and 80° C. with a current density of 1 to 4 A/dm² at 0.3 to 1.5 volts. The plating solution is continuously filtered and circulated in a conventional manner and the pH is controlled utilizing an acid or base material, as necessary, to maintain the pH between 4.2 an 4.8. The resulting thickness of the coating 50 on the cast silicon bronze part is from about 0.2 microns to about 5 microns. Prior to the coating process, typically the plumbing devices are cleaned in a 10% to 20% solution of hydrochloric acid for a brief period of time, as is conventional, to assure the quality of the plating deposit on the body of the component being electroplated.

Subsequent to the manufacture of the plumbing devices, such as the valve 10 or fitting 20, they are employed in a plumbing circuit, such as the example partial circuit 60 shown in FIG. 4, utilizing conventional low temperature lead-free solder 28, as indicated by step 34 in FIG. 5. Thus, for example as seen in FIG. 6, the junction between outlet 24 and tube 18 can be soldered in a typical solder “sweat” joint. The remaining connections are likewise soldered.

Thus, with the system of the present invention, plumbing fittings such as valves, T's, elbows, Y's, and the like can employ substantially lead-free (i.e., less than about 0.2% or less) silicon bronze alloys which are electroplated to allow soldering utilizing low temperature lead-free solder to provide fittings which meet lead-free potable water drinking standards and yet provide ease of installation in a plumbing system. Although two examples of silicon bronze alloys have been presented herein, other silicon bronze alloys having lead content less than about 0.2% could likewise be employed. Also, other electroplating solutions which provide a solderable surface to the silicon bronze fittings may be employed. Although entire fittings will typically be immersed in a bath to electroplate the inner and outer surfaces, if desired, it may be possible to only electroplate those surfaces which will be soldered to connecting tubes or pipes by suitable masking of the components during the electroplating process. As a general proposition, however, such selective electroplating may be commercially impractical.

It will become apparent to those skilled in the art that various modifications to the preferred embodiment of the invention as described herein can be made without departing from the spirit or scope of the invention as defined by the appended claims.

The invention claimed is:

1. A plumbing component comprising:
a body made of a metal having a lead content of less than about 0.2; and
wherein said body is plated with an alloy to allow solder to adhere to said body.

2. The component as defined in claim 1 wherein said metal is silicon bronze.

3. The component as defined in claim 1 wherein said body defines a valve body.

4. The component as defined in claim 1 wherein said body defines a fitting.

5. The component as defined in claim 1 wherein said body is electroplated.

6. The component as defined in claim 1 wherein said body is electroplated using an electroplating solution which includes nickel and tin salts.

7. The component as defined in claim 1 wherein said metal has a lead content less than about 0.15%.

8. A plumbing component comprising:
a body made of a silicon bronze alloy having a lead content of less than about 0.2%, said body including an end for receiving a connecting element to be soldered to said body; and
wherein said end of said body for receiving a connecting element is electroplated with a nickel tin alloy to allow lead-free solder to sealably couple the connecting element to said end of said body.

9. The component as defined in claim 8 wherein said body defines a valve body.

10. The component as defined in claim 8 wherein said body defines a fitting.

11. The component as defined in claim 8 wherein said metal has a lead content less than about 0.15%.

12. A method of manufacturing a plumbing component comprising the steps of:
forming a body made of a silicon bronze alloy having a lead content of less than about 0.2%; and
plating said body with an alloy to allow solder to adhere to said body.

13. The method as defined in claim 12 wherein said forming step comprise casting said body.

14. The method as defined in claim 13 wherein said casting step employs one of a C87800 and C87610 alloy.

15. The method as defined in claim 14 wherein said plating step is electroplating using a solution which includes nickel and tin salts.

16. A plumbing system comprising:
a plurality of components including at least one valve and at least one fitting which are made of silicon bronze having a lead content less than about 0.2% and are electroplated with a nickel tin alloy; and
copper tubing coupled to said components by lead-free solder.
